(19) United States
(12) Patent Application Publication
(10) Pub. No.: US 2006/0191318 A1
(43) Pub. Date: Aug. 31, 2006

(54) Digitally accessible sensor

(76) Inventors: Charles Leonard McBride, Burgettstown, PA (US); James Jerald Sawinski, Bellaire, OH (US); Wenfeng Peng, Moon Township, PA (US)

Correspondence Address: DENNISON, SCHULTZ & MACDONALD, 1727 KING STREET, SUITE 105, ALEXANDRIA, VA, 22314, US

(21) Appl. No.: 11/064,815

(22) Filed: Feb. 25, 2005

(51) Int. Cl. G01N 7/00

(52) U.S. Cl. 73/23.2

(57) ABSTRACT

A digitally accessible sensor (DAS) assembly includes a sensor, such as a gas sensor, attached to a printed circuit board which includes an analog-to-digital converter, and a digital interface. This modular design significantly shortens the analog signal path from the sensor and provides digital information to the instrument microcontroller, and thereby reduces noise levels from the sensor and circuitry. The circuit board design also includes a non-volatile memory unit allowing retention of information related to the sensor and its operation and/or the application, and may include an amplifier for amplifying the low level analog signal.

### BACKGROUND OF THE INVENTION

Gas detection instruments are an important category of electronic devices. They are used to detect, for example, methane in mines, toxic gases and oxygen deficiency in confined spaces, and toxic and hazardous gases in process plants and other workplaces. Because they are used to protect human life and property, the accuracy of these instruments is critical, requiring that not only the sensors but also the associated electronic circuitry perform with sensitivity and reliability.

Gas detection instruments employ a variety of sensor technologies, including catalytic combustion (disclosed in U.S. Pat. No. 6,742,382), metal oxide semiconductor (disclosed in U.S. Pat. No. 6,532,792), electrochemical (as disclosed in U.S. Pat. Nos. 6,370,940 and 6,129,825), infrared (disclosed in U.S. Pat. No. 6,843,102), and photo ionization (disclosed in U.S. Pat. Nos. 6,842,008 and 6,734,435). A typical sensor used in gas detection gives very low level output signals that require amplification before being applied to an analog-to-digital converter for resolution and then to the instrument microcontroller for conversion to parts per billion (PPB) or parts per million (PPM) measurements of the subject gas. In a traditional instrument design, sensors are mounted on one circuit board where amplifiers, microprocessors, and digital and analog devices are located.

Many electric components generate significant noise that interferes with low level measurements of electric signals. The noise generating components in a typical gas detection instrument include light emitting diodes (LED), switching regulators, audio and visual alarm devices, oscillators, and motors in the vibrator and the sample draw pump. Devices such as an LCD display and an audible alarm occupy large spaces, so routing these low level signals through the circuit board subjects them to signal distortion, which can cause unstable gas readings and false alarms.

Since all sensors have a specification for the sensitivity, the noise level of the circuit board determines the signal-to-noise ratio, and thus the lower detection limit, of the instrument. For example, a model 3E-300 carbon monoxide sensor made by SensoriC, Germany, has an output of 50-90 nA/ppm. As a typical instrument in the market has a noise level in the range of about 2 nA, measuring gas concentrations below 0.1 ppm (5-9 nA output) would be difficult, or impossible based on a desirable S/N ratio of at least 3. The S/N ratio can be measured in decibels as 20 log₁₀ 3=9.54 dB.

In addition, amplifiers that accept the sensor outputs and amplify the signal before inputting it to the analog-to-digital converter require different gain values since the sensor output levels vary significantly from gas to gas and sensor to sensor.

Considerable effort is made to reduce the deleterious effects of these outside noise sources. For example, large resistors induce noise, so many instruments use a digital potentiometer (disclosed, for example, in U.S. Pat. Nos. 5,608,207, 5,751,601, 5,996,396 and 6,462,825), in which the microprocessor picks a minimum acceptable value of resistance by sending a command to the potentiometer. Some instruments use a programmable gain amplifier (disclosed, for example, in U.S. Pat. Nos. 5,083,124, 6,837,096 and 6,342,919), which is an integrated circuit (IC) that combines an amplifier and a digital potentiometer. In some other instruments, a fixed resistor is used. A fixed resistor gives a limited range of measurements when compared to a variable resistor. These measures, however, do not produce desirable results because there are still long paths for the low level signal to travel across the circuit board.

At the present time several instrument manufacturers, including Industrial Scientific Corporation, Mine Safety Appliances Co., and RAE Systems, use a printed circuit board with the sensor. On the board, there is a non-volatile memory storing sensor type, serial number, and other information pertaining to the sensor, such as the history of temperature changes. The board is often referred to as an identification (ID) board and is fastened to the sensor on the side or on the bottom, so that when it is plugged into the instrument, the sensor type can be recognized and an appropriate potentiometer can be chosen to operate the sensor. The ID board also helps the instrument manufacturer investigate the root cause of a failure when the sensor is returned by a customer under warranty for a replacement. However, the instrument still suffers from noise due to extended paths of low level analog signals.

While the invention is most advantageous with respect to gas detection instruments in which a chemical signal is converted to an electrical signal, it is also applicable to other types of detectors in which a low level analog electrical output must be amplified, for example, a temperature sensor, a pressure sensor or a radiation sensor.

### SUMMARY OF THE INVENTION

It is therefore an object of the invention to provide a sensor module that not only carries important data relevant to the sensor and sensor operation, but also delivers reliable performance such as high sensitivity and low noise.

It is a further object of the invention to provide a sensor module which can be plugged into a universal circuit board that has a standard DC power supply and a digital interface without reconfiguring the hardware and software of the instrument.

According to the invention, the design problems of prior art circuit boards relating to noise pickup are minimized. The invention utilizes a Digitally Accessible Sensor, herein referred to by the term “DAS.” In the DAS, a small printed circuit board serves as a carrier for the sensor and for associated active and passive components. This DAS board is referred to as a “quiet” board, characterized in that it excludes components, for example LED's, alarms, motors and display components, which generate noise that interferes with low level analog signals. The purpose of the quiet DAS board is to eliminate the routing of analog signals through the main circuit board of the detection instrument in which the DAS is used. An added benefit is that the components do not occupy main instrument circuit board space.

To accomplish the above objects, the invention is directed to an assembly comprising:

a sensor unit which produces an analog electrical output upon exposure to a stimulus of interest; and

a printed circuit board physically and electrically attached to the sensor unit, and additionally having components thereon comprising means for converting the analog electrical output to a digit al output, a digital interface connected to the digital output of the means for converting, a non-volatile memory unit and means for providing digital output from the digital interface to a separate instrument circuit board. Where desired, the printed circuit board may also comprise at least one amplifier.

The amplifier and the analog-to-digital converter are thus located immediate to the sensor on the same DAS circuit board, with no significant noise sources on the DAS board. This reduces the analog path to a very short distance. The analog-to-digital converter on the DAS board provides digital information to the instrument microcontroller by utilizing digital serial signaling, which is not as susceptible to noise and interference as are the low level analog signals. Use of the DAS board enables improvement in the signal-to-noise ratio of 6 dB or more.

Among the sensors which may be used with the DAS board are chemical and biochemical sensors, as well as catalytic combustion sensors, electrochemical sensors, semiconductor sensors, calorimetric sensors, infrared sensors, surface acoustic wave sensors, temperature sensors, pressure sensors, humidity sensors, radiation sensors and photo ionization sensors.

Regardless of sensor type, a DAS board can be plugged into any DAS-designated slot on a standard main circuit board since the DAS board carries not only the sensor information but also sensor operating circuitry. As long as an a appropriate power source, for example 5 VDC, is supplied, the board provides an output signal that can be converted to the concentration of gas present. This eliminates the problem with sensor misplacement on the main board when the board is configured to accommodate multiple sensors, and enables DAS boards with different types of sensors to be readily interchanged.

Moreover, because the DAS output is a digital signal, which is less susceptible to noise interference than an analog signal, the physical connection of the DAS board to the main instrument circuit board can be extended by either fixed or flexible cables or wires, which allows the instrument to be used for spot checks and detection of gases in areas inaccessible or potentially dangerous to human beings.

### BRIEF DESCRIPTION OF THE DRAWINGS

The invention is illustrated in the accompanying drawings, in which:

FIG. 1 is a block diagram of a sensor module according to one embodiment of the invention;

FIG. 2 is an electronic schematic diagram of a DAS board according to a preferred embodiment of the invention;

FIG. 3 is a perspective view of a DAS sensor assembly;

FIG. 4 is a side view, in partial cross-section, showing the connection of a DAS board to the main circuit board of an instrument; and

FIG. 5 is a perspective view of a further embodiment of the invention.

### DESCRIPTION OF THE PREFERRED EMBODIMENTS

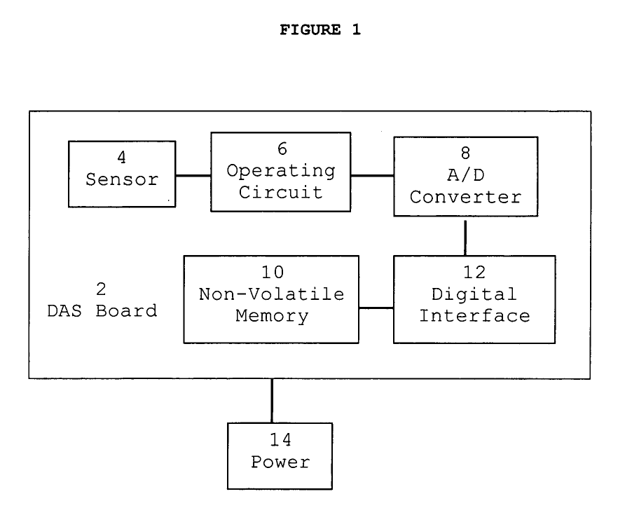

As shown in FIG. 1, the DAS board 2 according to the invention includes five major components, a gas sensor 4, a sensor operating circuit 6, an analog-to-digital (A/D) converter 8, a non-volatile memory 10 and digital interface 12. The board is powered by an external power source 14. The A/D converter 8 and the non-volatile memory are connected to the digital interface 12.

The gas sensor 4 converts the gas concentration to either a current or voltage output at extremely low levels. The sensor 4 is operated by a sensor operating circuit 6, which is appropriate to the sensor, and which is well known in the art. For example, an electrochemical sensor requires a potentiostat, which applies a bias voltage to the sensor and then amplifies the current output. A catalytic combustion sensor is operated by a Wheatstone bridge, which applies a constant voltage to two catalytic beads and then measures changes in the resistance.

The sensor operating circuit also measures the signal from the sensor. The range of this input to the sensor operating circuit is dependent upon the sensor and the gas which it is measuring. The gas sensor has no drive capability and, if its output level is low, it must be increased by applying it to the input of an amplifier which will amplify and condition the gas sensor output to a level sufficient for a practical measuring circuit. This circuit includes a gain adjustment circuit which holds the gain at a predetermined fixed value or at a value adjusted based on the sensor sensitivity.

The output from the sensor operating circuit 6 is applied to the input of the analog-to-digital converter 8 which converts the signal output into an accurate digital representation of the gas sensor output. The analog-to-digital converter 8 may output its digital representation either when requested or continuously, dependent upon the analog-to-digital type. The bit resolution of the analog-to-digital converter is determined by the resolution required by the instrument. This digital information may be accessed by a controller such as a microprocessor with use of the circuitry of the digital interface 12. The digital representation is connected to the controller that displays or outputs the information in a format and method dictated by the user requirements and/or the specific application. For example, an SPI (Serial Peripheral Interface) bus may be used for communications between the digital interface and the instrument microcontroller. The SPI bus is a 3- or 4-wire serial synchronous interface for communication between chips. With minor changes to the components, it is also possible to use an I2C (Inter-Integrated Circuit Control), a two wire serial synchronous interface for communication between a master and many slaves. Other communications means may also be used.

A non-volatile memory 10 may be used to store information about the DAS board itself, such as sensor type, date of manufacture, serial number, sensitivity, calibration data, temperature, temperature coefficients, dead band, baseline limits, resolution, gain value, cross-sensitivity factors, linearization algorithms and coefficients, Time Weighted Average (TWA), Short Term Exposure Limit (STEL), and high and low alarm threshold values. The memory can also store other information needed by the application.

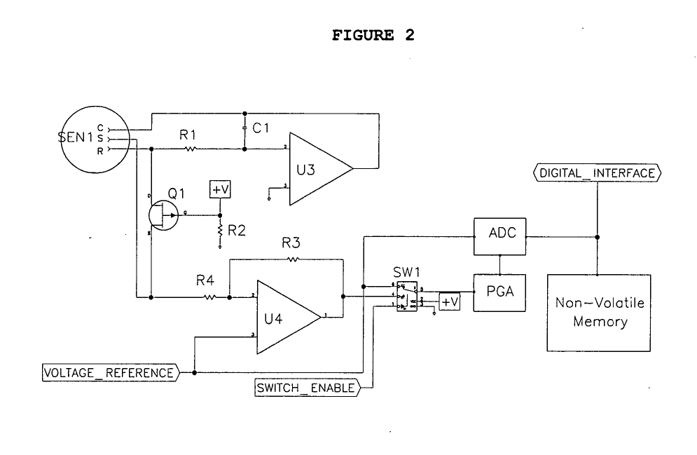

FIG. 2 is a schematic of a preferred embodiment of the invention. The circuit shown in FIG. 2 is designed to work with an electrochemical gas sensor for the detection of toxic gases, such as carbon monoxide and hydrogen sulfide. The sensor SEN1 has three electrodes, a sensing or working electrode S, a reference electrode R, and a counter electrode C. The sensor operating circuit includes two operational amplifiers, U3 and U4. The sensing electrode S is held at a potential with reference to the reference electrode R via a bias voltage, designated “voltage _reference,” and the current generated at the sensing electrode is allowed to pass the counter electrode only. When the sensor does not require a bias voltage and the sensor is not powered, the sensing electrode S and the reference electrode R are shorted by a Junction Field Effect Transistor (JFET) Q1, allowing for faster startup when power is turned back on and the JFET Q1 switch is opened. The current signal from the sensor is amplified by amplifier U4 and the analog signal can be further amplified by a Programmable Gain Amplifier (PGA).

The analog signal from the PGA is converted to a digital signal by a analog to digital converter, ADC. This digital signal can be stored by the non-volatile memory such as an Electrically Erasable Programmable Read Only Memory (EEPROM), or a digital interface such a microprocessor, programmable logic element, Application Specific Integrated Circuit (ASIC) or combination thereof which is mounted on the DAS board.

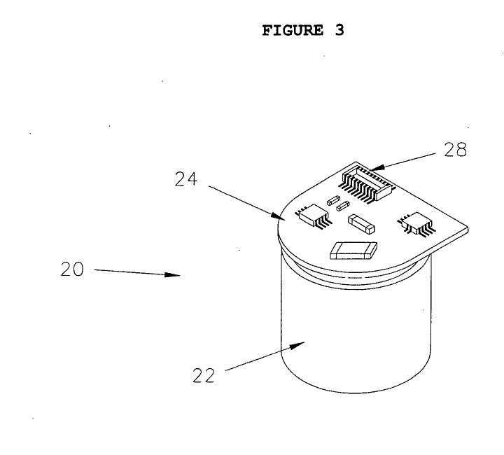

FIG. 3 shows the physical arrangement of the DAS sensor. The sensor assembly 20 includes a sensor 22, a DAS board 24 with various components described above, and a digital interface 28, through which digital signal may be read. The DAS board 24 is attached to the bottom of the sensor 22, for example, by gluing, use of double sided tape, friction fit or snap fit. The DAS board may also be attached to the sensor by soldering, although this is generally not recommended by sensor manufacturers.

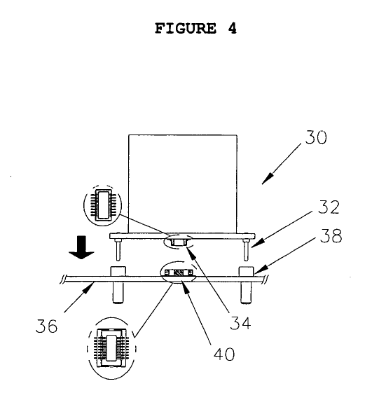

A connection of the DAS board to the main circuit board of an instrument is shown in FIG. 4, in which DAS board 30 has mounting pins 32 and a male connector 34 that is connected to the digital interface on the DAS board. The main circuit board 36 of the instrument has mounting sockets 38 which receive the mounting pins 32, thereby aligning the DAS board 30 so that the male connector 34 sits in female connector 40 on the main board 36, with the microcontroller on the main board communicating with the digital interface on the DAS board. A suitable set of male and female connectors is manufactured by Molex Inc. of Japan under Model Nos. 54722 and 55560 slim line connectors.

While this type of physical connection between the DAS board and the main board is currently preferred, it is also possible to use a wireless connection, for example radio frequency or infrared, to transmit digital information from the DAS board to the main circuit board, in a manner known in the art for transmitting digital information.

Power may be sent to the DAS board through pins 32 and sockets 38, or through a separate connection to the DAS board.

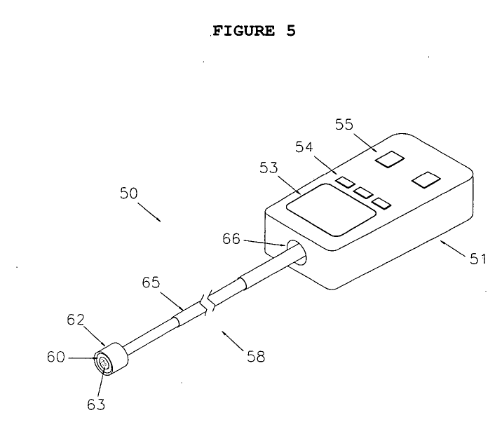

FIG. 5 illustrates an instrument capable of detecting gases remote from the main instrument circuitry. The instrument 50 has a handheld unit 51 equipped with a LCD display 53, alarm devices 54, and operating buttons 55, all connected to the main instrument board (not shown). The instrument has a retractable probe 58 with a sensor 60 on the opposite end. The sensor 60 is mounted in a protective housing 62 which allows the sensor to expose to gas through an opening 63. The sensor includes a DAS board (not shown) connected to the main instrument board by a cable (not shown) placed inside retractable tubing 65, which may extend several feet from the main instrument body. In applications not requiring remote sensing or when the instrument is not in use, the probe 58 is retracted such that the sensor assembly rests in recess 66 in the instrument case.

The DAS board may be assembled in several ways. For example, the active and passive components may be in standard packages which may be readily obtained from the shelf. The disadvantage the area required for mounting the individual components on the printed circuit board. Since the intent is to attach the DAS directly to a small sensor, considerable effort is required to keep the DAS board size approximately the same as the sensor size. The active and passive components are also available in die form, in which the components are typically much smaller. The die is connected utilizing wire bonding to minimize the area required for the interconnecting wires/traces. The circuit can also be made in the form of a flexible circuitry. In this arrangement, the circuit may be protected by a conformal coating of epoxy or other similar material.

Alternatively, the DAS board design may involve custom manufacture, which does not utilize existing components but rather develops equivalents to them, all within what will appear as an integrated circuit package mounted on the DAS board. While custom manufacture produces the most advantageous product, the method is costly and is the least preferred method unless very high volumes are anticipated.

The DAS board can also be made as an integral part of the sensor. Thus, instead of being attached to the sensor, it can be built into the sensor housing.

What is claimed is:

1. An assembly comprising:
a sensor unit which produces an analog electrical output upon exposure to a stimulus of interest; and
a printed circuit board physically and electrically attached to the sensor unit, and additionally having components thereon comprising means for converting the analog electrical output to a digital output, a digital interface connected to the digital output of the means for converting, a non-volatile memory unit and means for providing digital output from the digital interface to a separate instrument circuit board,
said printed circuit board excluding components which generate noise sufficient to interfere with the analog electrical output of the sensor unit.

2. The assembly of claim 1, wherein the circuit board additionally comprises an amplifier.

3. The assembly of claim 1, wherein the non-volatile memory unit is an EEPROM.

4. The assembly of claim 1, wherein the means for converting comprises an analog to digital converter.

5. The assembly of claim 1, wherein the circuit board additionally comprises a physical connector constructed and arranged to connect to a corresponding connector on the separate instrument circuit board.

6. The assembly of claim 5, wherein the physical connector comprises pins constructed and arranged to plug into a socket on the separate instrument circuit board.

7. The assembly of claim 6, wherein the physical connector comprises a cable or wires which extend a distance from the main circuit board.

8. The assembly of claim 7, wherein the cable or wires pass through a fixed or telescoping housing.

9. The assembly of claim 1, wherein the sensor unit converts a chemical or biochemical signal to an electrical signal.

10. The assembly of claim 9, wherein the sensor is a gas sensor.

11. The assembly of claim 1, wherein the sensor is selected from the group consisting of a catalytic combustion sensor, a thermal conductivity sensor, an electrochemical sensor, a semiconductor sensor, a calorimetric sensor, an infrared sensor, a surface acoustic wave sensor, a temperature sensor, a pressure sensor, a humidity sensor, a radiation sensor and a photo ionization sensor.

12. The assembly of claim 5, wherein the printed circuit board is constructed and arranged to receive electrical power through the physical connector from the separate circuit board.

13. The assembly of claim 1, wherein the printed circuit board is constructed and arranged to receive electrical power through a direct connection to a power source.

14. The assembly of claim 1, wherein the printed circuit board comprises at least one additional component selected from the group consisting of an amplifier, an analog-to-digital converter, a non-volatile memory unit, and a digital interface.

15. The assembly of claim 2, wherein the amplifier includes a gain adjustment circuit.

16. The assembly of claim 1, wherein the non-volatile memory stores information related to the sensor selected from, the group consisting of sensor type, date of manufacture, sensor serial number, sensitivity, calibration data, temperature, temperature coefficients, dead band, baseline limits, resolution, gain value, cross-sensitivity factors, linearization algorithms and coefficients, Time Weighted Average (TWA), Short Term Exposure Limit (STEL), and high and low alarm threshold values temperature changes, and combinations thereof.

17. The assembly of claim 1, wherein the digital interface includes a microprocessor, microcontroller, programmable logic element, Application Specific Integrated Circuit (ASIC) or combination thereof.

18. The assembly of claim 1, wherein the sensor and printed circuit board are physically connected by an adhesive, a friction fit, a snap fit or double sided tape.

19. The assembly of claim 1, wherein the components thereon are in die form.

20. The assembly of claim 1, wherein the components thereon are in the form of an integrated circuit.

21. The assembly of claim 1, wherein the sensor unit comprises a housing in which the printed circuit board is formed or contained.

22. An assembly consisting essentially of:
a sensor unit which produces an analog electrical output upon exposure to a stimulus of interest; and
a printed circuit board physically and electrically attached to the sensor unit, and additionally having components thereon comprising means for converting the analog electrical output to a digital output, a non-volatile memory unit, a digital interface connected to the digital output of the means for converting, means for providing digital output from the digital interface to a separate instrument circuit board, and optionally an amplifier.

23. A gas detection instrument comprising an assembly according to claim 1, wherein the connector means is connected to a separate instrument circuit board comprising a microcontroller.

24. A gas detection instrument according to claim 23, wherein the separate circuit board additionally comprises an visual display means, an audible alarm means or both an visual display means and an audible alarm means.

25. A gas detection instrument according to claim 23, wherein the circuit board is connected to the separate instrument circuit board through a pin and socket arrangement.

26. A gas detection instrument according to claim 23, wherein the circuit board is connected to the separate instrument circuit board by a cable or wires.

27. A gas detection instrument according to claim 26, additionally comprising a housing through which the cable or wires pass, and which extends a distance from the separate circuit board.
